(19) United States
(12) Patent Application Publication
(10) Pub. No.: US 2017/0104572 A1
(43) Pub. Date: Apr. 13, 2017

(54) METHOD FOR INTERFERENCE MITIGATION, NETWORK SERVER AND BASE STATION USING THE SAME

(71) Applicant: INDUSTRIAL TECHNOLOGY RESEARCH INSTITUTE, Hsinchu (TW)

(72) Inventors: Chia-Lung LIU, Zhubei City (TW); Guan-Hsien DU, Hsinchu City (TW); Fu-Te HSU, Taoyuan City (TW)

(73) Assignee: INDUSTRIAL TECHNOLOGY RESEARCH INSTITUTE, Hsinchu (TW)

(21) Appl. No.: 14/979,963

(22) Filed: Dec. 28, 2015

(30) Foreign Application Priority Data
Oct. 8, 2015 (TW) 104133184

(51) Int. Cl. H04L 5/00; H04W 72/08; H04L 5/14

(52) U.S. Cl. CPC H04L 5/0073; H04L 5/1461; H04W 72/082; H04L 5/0014

(57) ABSTRACT

A method for interference mitigation, a network server, and a base station are provided. The method for interference mitigation includes the following steps. A transmitting group is created by grouping a first base station and a first user equipment, the transmitting group including multiple transmitting antennas. A receiving group is created by grouping a second base station and a second user equipment, the receiving group comprising multiple receiving antennas. Channel information between each transmitting antenna and each receiving antenna is obtained to calculate multiple interference coefficients between each transmitting antenna and each receiving antenna. Precoding is performed on the transmitting antennas according to the interference coefficients.

This application claims the benefit of Taiwan application Serial No. 104133184, filed Oct. 8, 2015, the subject matter of which is incorporated herein by reference.

### TECHNICAL FIELD

The disclosure relates to a method for interference mitigation utilizing precoding techniques.

### BACKGROUND

With the growth of mobile communication, mobile operators use small cells to extend their service coverage and increase network capacity. For example, the density of deployed small cell may be up to one thousand per square kilometer, thus forming an ultra dense network (UDN). Dynamic time division duplex (TDD) technique may be adopted in the UDN, such that the configuration used for the uplink (UL) transmission and for the downlink (DL) transmission may be adjusted dynamically according to the network traffic requirement. However, when there is an overlapped region between the coverage areas of different base stations, there may be interference between UL and DL in the dynamic TDD environment. Thus, there is a need for a method to mitigate interference caused by different UL/DL configurations between base stations.

### SUMMARY

The disclosure is directed to a method for interference mitigation, a network server and a base station using the same.

According to one embodiment, a method for interference mitigation is provided. The method includes: creating a transmitting group by grouping a first base station and a first user equipment, the transmitting group including multiple transmitting antennas; creating a receiving group by grouping a second base station and a second user equipment, the receiving group including multiple receiving antennas; obtaining channel information between each transmitting antenna and each receiving antenna to calculate multiple interference coefficients between each transmitting antenna and each receiving antenna; and performing precoding on the transmitting antennas according to the interference coefficients.

According to another embodiment, a network server is provided. The network server includes a grouping unit, a channel processing unit, and a precoding unit. The grouping unit is configured to create a transmitting group by grouping a first base station and a first user equipment, and create a receiving group by grouping a second base station and a second user equipment, wherein the transmitting group includes multiple transmitting antennas, and the receiving group includes multiple receiving antennas. The channel processing unit is configured to obtain channel information between each transmitting antenna and each receiving antenna to calculate multiple interference coefficients between each transmitting antenna and each receiving antenna. The precoding unit is configured to perform precoding on the transmitting antennas according to the interference coefficients.

According to still another embodiment, a base station is provided. The base station includes a schedule processing unit, a channel report unit, and a precoding execution unit. The schedule processing unit is configured to identify a user equipment that is currently being scheduled, and transmit information about the base station and the user equipment to a network server. The channel report unit is configured to obtain base station channel information related to the base station, obtain user equipment channel information related to the user equipment, and transmit the base station channel information and the user equipment channel information to the network server. The precoding execution unit is configured to receive a precoding result from the network server and to implement it in current transmission.

### BRIEF DESCRIPTION OF THE DRAWINGS

FIG. 1 shows a diagram illustrating an example of interference condition in a time division duplex system.

FIG. 2 shows a diagram illustrating beamforming between a base station and a user equipment.

FIG. 3 shows a communication system according to an embodiment of this disclosure.

FIG. 4 shows a diagram illustrating channel measurement of the base station and the user equipment.

FIG. 5 shows a diagram illustrating the base station reporting channel information to the network server.

FIG. 6 shows a diagram illustrating the grouping of the base station and the user equipment according to an embodiment of this disclosure.

FIG. 7 shows a diagram illustrating the network server transmitting a precoding result according to an embodiment of this disclosure.

FIG. 8 shows a flowchart illustrating an interference mitigation method according to an embodiment of this disclosure.

FIG. 9 shows a flowchart illustrating an interference mitigation method according to an embodiment of this disclosure.

FIG. 10 shows a block diagram of the network server according to an embodiment of this disclosure.

FIG. 11 shows a block diagram of the network server according to an embodiment of this disclosure.

FIG. 12 shows a block diagram of the base station according to an embodiment of this disclosure.

FIG. 13 shows a diagram illustrating the network server, the base station and the user equipment according to an embodiment of this disclosure.

FIG. 14A shows a diagram illustrating an example of interference between base stations.

FIG. 14B shows a diagram illustrating an example of interference between user equipments.

FIG. 14C shows a diagram illustrating an example of grouping the base station and the user equipment.

FIG. 14D shows a diagram illustrating an example of splitting a group into two subgroups.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the current TDD schemes, for example, TDD used in a Long Term Evolution (LTE) system, there are seven different configurations for a frame structure, as listed in Table 1 below. In Table 1, D represents a DL subframe, U represents a UL subframe, and S represents a special subframe. The special subframe consists of Downlink Pilot Time Slot (DwPTS), Uplink Pilot Time Slot (UpPTS), and Guard Period (GP).

TABLE 1

| | Downlink to | | | | | | | | | | |
|---|---|---|---|---|---|---|---|---|---|---|---|
| | Uplink | | | | | | | | | | |
| | Switch-point | Subframe number | | | | | | | | | |
| Configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

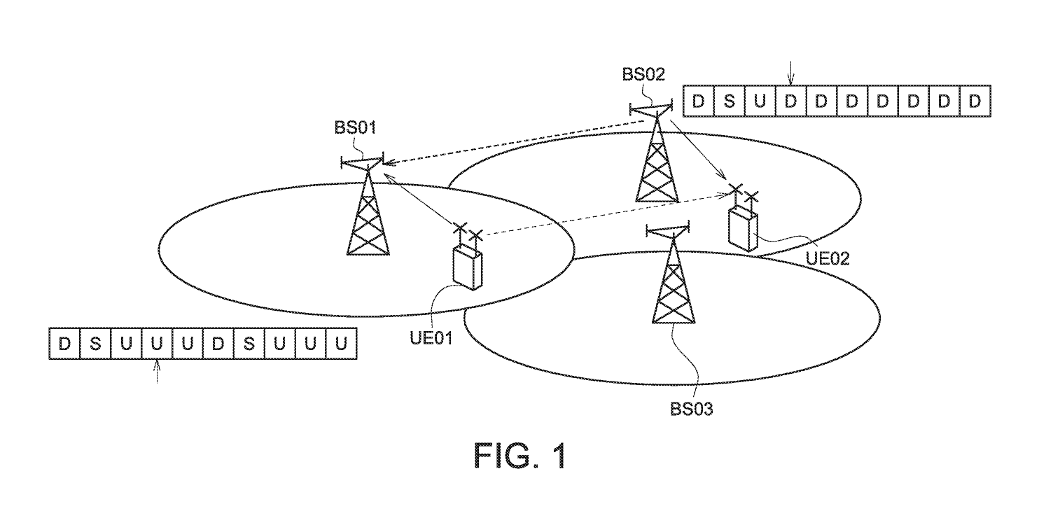

In a system where dynamic TDD technique is applied, because each base station is able to dynamically adjust the TDD configuration to be used, neighboring base stations may use different TDD configurations, which may result in interference between UL and DL. One example of such interference condition may be referred to in FIG. 1.

FIG. 1 shows a diagram illustrating an example of interference condition in a time division duplex system. The base station BS01 and the base station BS02 are neighboring to each other. The base station BS01 serves the user equipment UE01, and the base station BS02 serves the user equipment UE02. The base station BS01 uses the TDD configuration 0 as listed in Table 1, while the base station BS02 uses the TDD configuration 5. As can be seen in Table 1, in the subframe 3, the base station BS01 is in uplink status, that is, the user equipment UE01 is transmitting data to the base station BS01. On the other hand, the base station BS02 is in downlink status, that is, the base station BS02 is transmitting data to the user equipment UE02 (shown as solid lines in FIG. 1). Because the two base stations are neighboring to each other, signals broadcasted from the base station BS02 are also transmitted to the base station BS01 (shown as a dashed line in FIG. 1). Hence the base station BS01 simultaneously receives signals from the base station BS02 as well as from the user equipment UE01, resulting in DL-to-UL interference. Similarly, signals broadcasted from the user equipment UE01 may also be transmitted to the user equipment UE02 (shown as a dashed line in FIG. 1). The user equipment UE02 simultaneously receives signals from the base station B502 as well as from the user equipment UE01, resulting in UL-to-DL interference.

For the DL-to-UL interference and the UL-to-DL interference as mentioned in the above example, the method proposed in this disclosure may utilize beamforming technique with multiple antennas in order to mitigate interference. Transmission in the same time and in the same frequency can be achieved to effectively utilize the network resources.

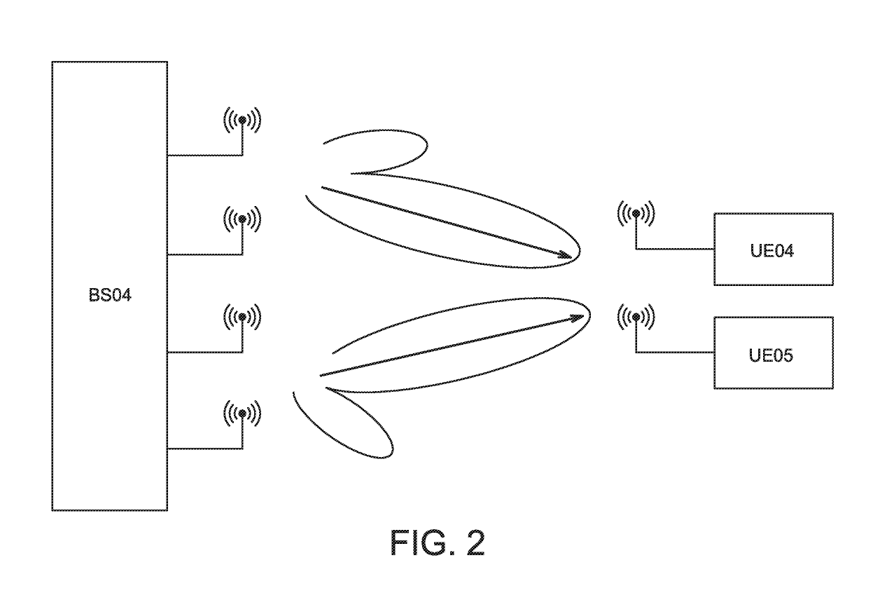

FIG. 2 shows a diagram illustrating beamforming between a base station and a user equipment. In this example a base station transmits data to multiple user equipments. Multiple antennas of the base station BS02 and multiple antennas of the user equipment UE04 and UE04 form multipath. The effects of multipath include constructive and destructive interference. Beamforming may be achieved by performing precoding on the multiple antennas of the base station BS04. One example of the beamforming technique is to use a zero-forcing calculation method to determine appropriate precoding matrix coefficients according to the channel information. Because the signals transmitted from the multiple antennas have been precoded, two paths transmitted in the same time and in the same frequency can be achieved to mitigate multipath interference from the base station BS04.

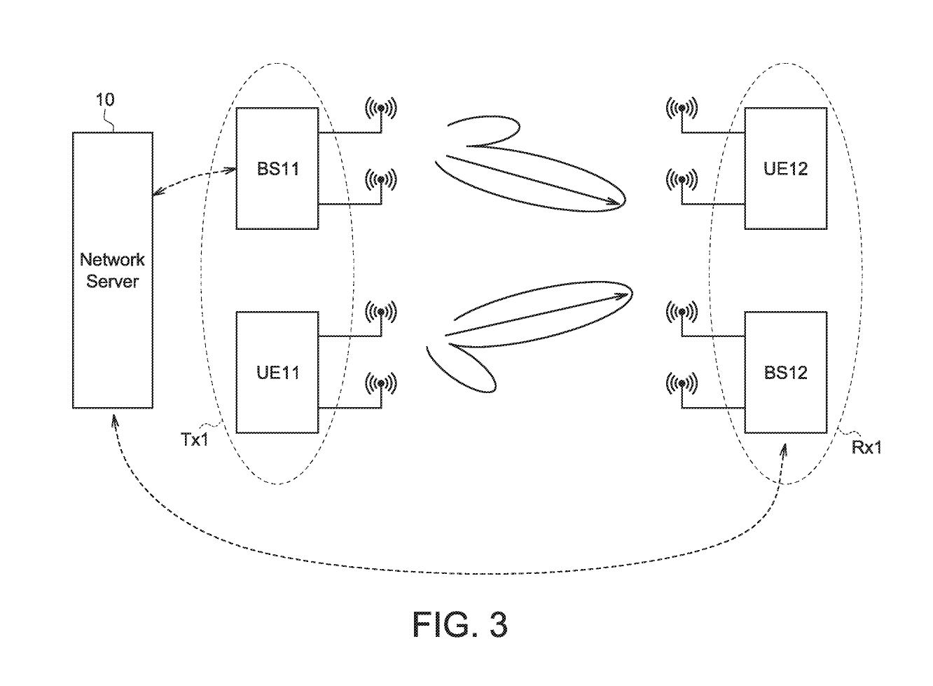

The example shown in FIG. 2 is beamforming in a single base station. As for the DL-to-UL interference and UL-to-DL interference between neighboring base stations, one example system proposed in this disclosure is shown in FIG. 3.

FIG. 3 shows a communication system according to an embodiment of this disclosure. The system includes a network server 10, a first base station BS11, a second base station BS12, a first user equipment UE11, and a second user equipment UE12. The network server 10 may be connected to the first base station BS11 and the second base station BS12 via wired network interface, such as X2 interface and S1 interface as defined in The 3rd Generation Partnership Project (3GPP) specification. The first base station BS11 and the second base station BS12 may communicate with the first user equipment UE11 and the second user equipment UE12 via air interface, such as LTE technology. In this system, a transmitting group Tx1 is created by grouping the first base station BS11 and the first user equipment UE11. The transmitting group Tx1 may be regarded as a virtual transmitting terminal. In addition, a receiving group Rx1 is created by grouping the second base station BS12 and the second user equipment UE12. The receiving group Rx1 may be regarded as a virtual receiving terminal. The grouping procedure may be determined and performed by the network server 10. After the grouping procedure, the system may be regarded as a transmitting terminal with multiple antennas (the transmitting group Tx1) and a receiving terminal with multiple antennas (the receiving group Rx1). Thus the precoding method shown in FIG. 2 may be applied to the system in order to mitigate multipath interference between the transmitting group Tx1 and the receiving group Rx1. In this example, the first base station BS11 serves the second user equipment UE12, and the second base station BS12 serves the first user equipment UE11. Specifically, the first base station BS11 transmits data to the second user equipment UE12 in a downlink channel, and the first user equipment UE11 transmits data to the second base station BS12 in an uplink channel. The method and the devices in this system are described in detail in the following description.

The network server 10 in the system shown in FIG. 3 may be a self-organizing network (SON) server. A SON is an automation technology designed to make the planning, configuration, management, optimization and healing of mobile radio access networks simpler and faster. A server may be deployed in a SON to handle information of each base station in the SON and send related control signals to each base station. As shown in FIG. 3, the network server 10 may receive information from each base station and also transmit control signal to each base station.

The first base station BS11 and the second base station BS12 may be macrocells or small cells. Small cells may include microcells, picocells, and femtocells, such as a Home evolved Node B (HeNB) in a LTE system. The first user equipment UE11 and the second user equipment UE12 may be mobile phones, table computers, laptop computers, and other types of mobile devices with wireless communication capability.

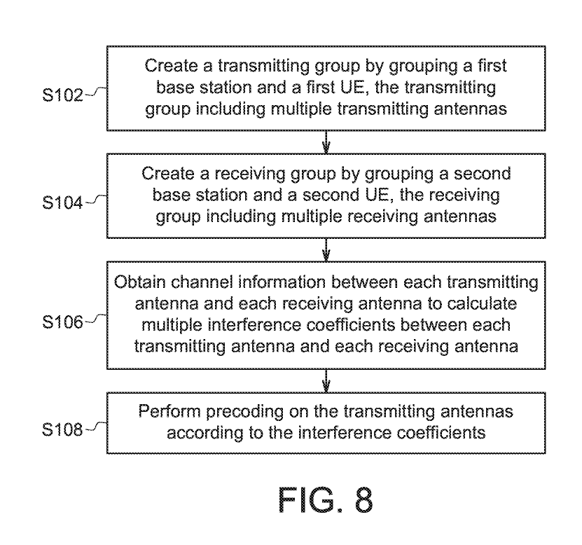

The method for interference mitigation used in the system shown in FIG. 3 may be referred to in FIG. 8. FIG. 8 shows a flowchart illustrating an interference mitigation method according to an embodiment of this disclosure. The method includes the following steps. Step S102: create a transmitting group by grouping a first base station and a first user equipment, the transmitting group including multiple transmitting antennas. Step S104: create a receiving group by grouping a second base station and a second user equipment, the receiving group including multiple receiving antennas. Step S106: obtain channel information between each transmitting antenna and each receiving antenna to calculate multiple interference coefficients between each transmitting antenna and each receiving antenna. Step S108: perform precoding on the transmitting antennas according to the interference coefficients. Individual steps in FIG. 8 are connected by arrows for ease of understanding. However, the execution order of each step is not limited thereto. For example, the steps S102, S104, and S106 may be performed in parallel since there is no data dependency between these steps.

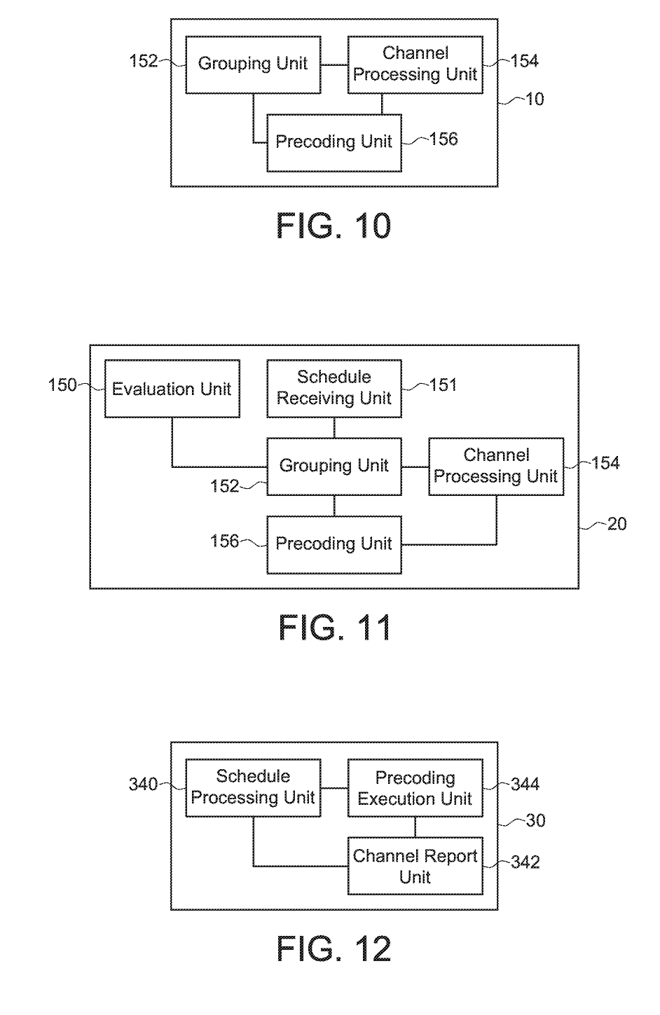

The method for interference mitigation shown in FIG. 8 may be implemented in the network server 10. FIG. 10 shows a block diagram of the network server according to an embodiment of this disclosure. The network server 10 includes a grouping unit 152, a channel processing unit 154, and a precoding unit 156. The grouping unit 152 is configured to create a transmitting group Tx1 by grouping a first base station BS11 and a first user equipment UE11, and create a receiving group Rx1 by grouping a second base station BS12 and a second user equipment UE12, wherein the transmitting group Tx1 includes multiple transmitting antennas, and the receiving group Rx1 includes multiple receiving antennas. The channel processing unit 154 is configured to obtain channel information between each transmitting antenna and each receiving antenna to calculate multiple interference coefficients between each transmitting antenna and each receiving antenna. The precoding unit 156 is configured to perform precoding on the transmitting antennas according to the interference coefficients. The steps shown in FIG. 8 and the units shown in FIG. 10 are described in detail in the following description.

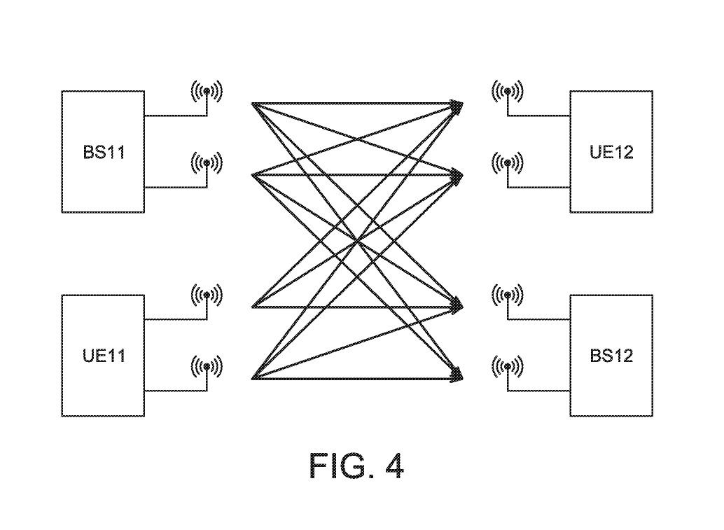

FIG. 4 shows a diagram illustrating channel measurement of the base station and the user equipment. The transmitting group Tx1 includes multiple transmitting antennas. The receiving group Rx1 includes multiple receiving antennas. There is one channel between each transmitting antenna and each receiving antenna. As such, for p transmitting antennas and q receiving antennas, there are a total of p*q channels. To obtain information regarding the severity of interference, channel estimation may be performed on these p*q channels to obtain the channel response of each channel.

In the example shown in FIG. 4, there are 16 channels. The channel information in the system includes: a channel response between the first base station BS11 and the second base station BS12, a channel response between the first base station BS11 and the second user equipment UE12, a channel response between the first user equipment UE11 and the second base station BS12, and a channel response between the first user equipment UE11 and the second user equipment UE12. These channel responses may be obtained by continuous channel estimation performed by each base station BS11, BS12 and each user equipment UE11, UE12. For example, channel estimation may be performed every 1 ms to obtain the channel response in real time.

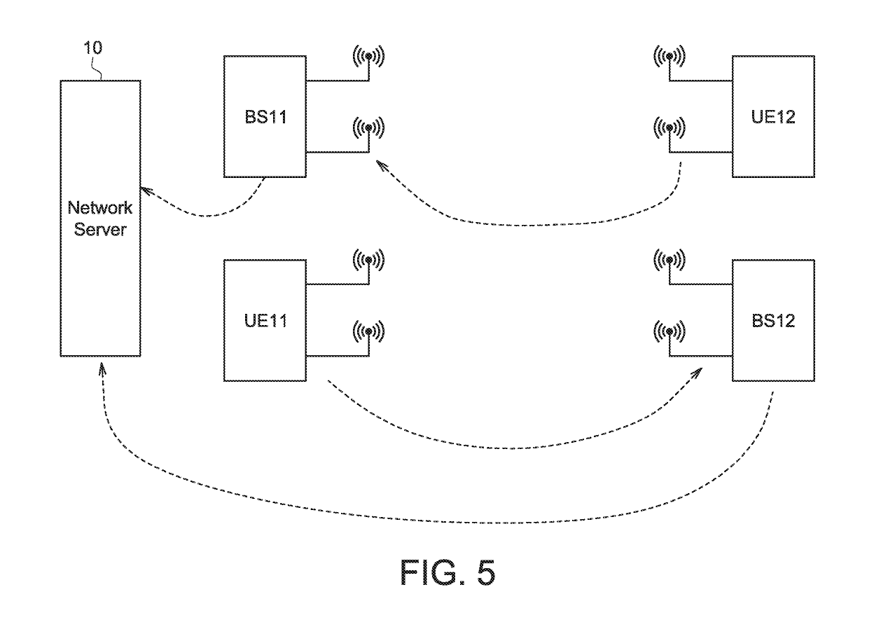

The channel responses obtained by channel estimation may be reported to the network server 10 (corresponding to the step S106). The channel processing unit 154 of the network server 10 collects the channel information. FIG. 5 shows a diagram illustrating the base station reporting channel information to the network server. The first base station BS11 and the second base station BS12 are directly connected to the network server 10. The channel estimation result of the first base station BS11 and the second base station BS12 may thus be reported to the network server 10 directly. The channel estimation result of the first user equipment UE11 may be first transmitted to the second base station BS12 and then reported to the network server 10 via the second base station BS12. Similarly, the channel estimation result of the second user equipment UE12 may be first transmitted to the first base station BS11 and then reported to the network server 10 via the first base station BS11.

After collecting channel information, multiple interference coefficients between each transmitting antenna and each receiving antenna may be calculated according to the channel information (step S106). This step may be performed by the channel processing unit 154. For example, one specific antenna in the receiving group Rx1 may receive signals from four transmitting antennas, wherein one of the transmitting antennas constitutes a main transmission channel with the specific antenna in the receiving group Rx1, while the other three transmitting antennas constitute interference. The interference coefficients may be calculated according to the channel responses of these four channels. The interference coefficient may be in the unit of dBm.

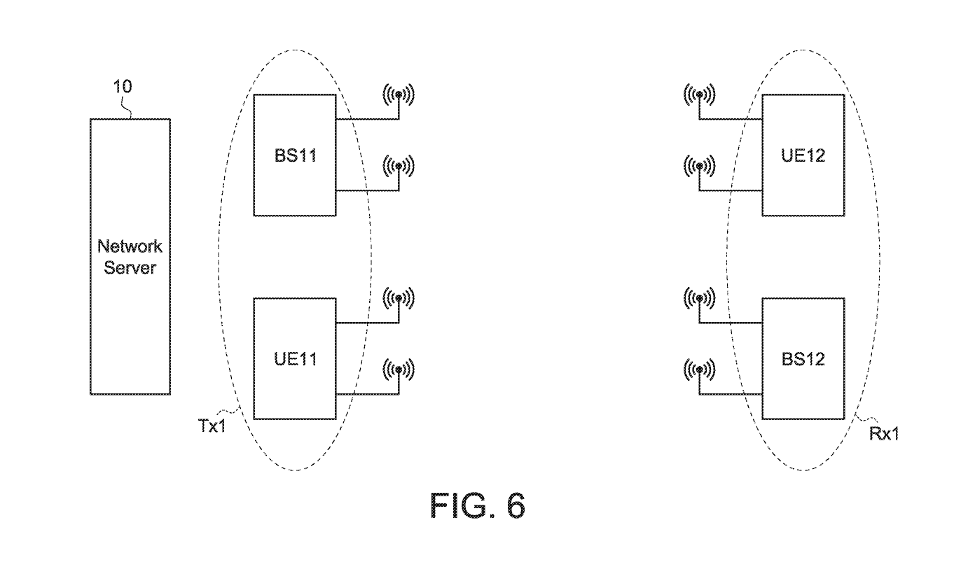

FIG. 6 shows a diagram illustrating the grouping of the base station and the user equipment according to an embodiment of this disclosure (corresponding to the steps S102 and S104). These steps may be performed by the grouping unit 152. The first user equipment UE11 is located in the coverage area of the second base station BS12. The second user equipment UE12 is located in the coverage area of the first base station BS11. Based on the TDD configuration chosen by these two base stations, the first base station BS11 (DL) and the first user equipment UE11 (UL) transmit data. Therefore the first base station BS11 and the first user equipment UE11 are grouped together to create the transmitting group Tx1. The second base station BS12 (UL) and the second user equipment UE12 (DL) receive data. Therefore the second base station BS12 and the second user equipment UE12 are grouped together to create the receiving group Rx1. Because a group is created by grouping a base station and a user equipment that belong to different coverage areas of different base stations, interference condition that exists between neighboring base stations can be considered in this approach.

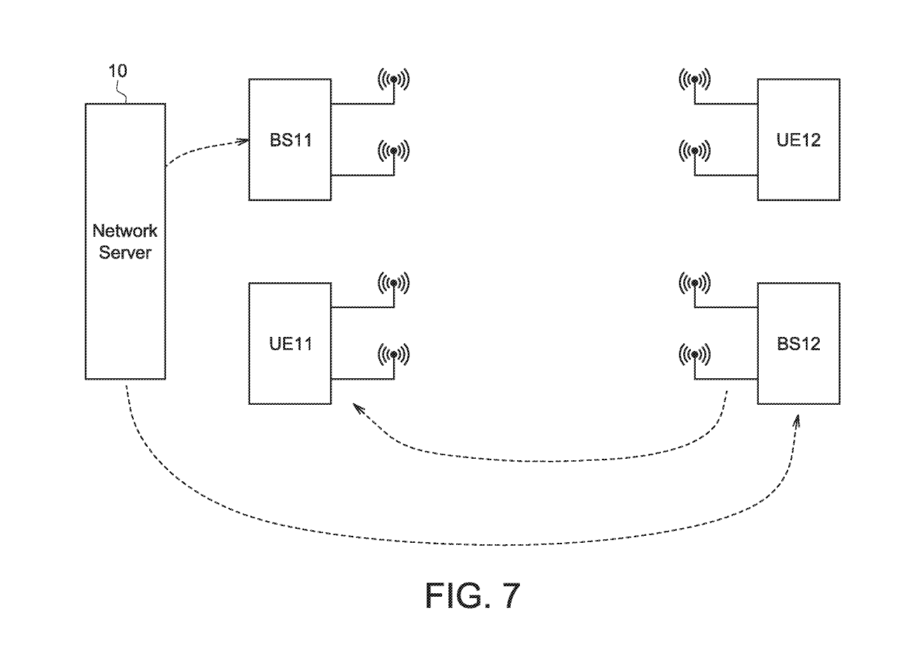

FIG. 7 shows a diagram illustrating the network server transmitting a precoding result according to an embodiment of this disclosure. After knowing the interference coefficients and executing the grouping procedure, precoding may be performed on the transmitting antennas (step S108) to mitigate multipath interference between the transmitting group Tx1 and the receiving group Rx1. The step may be performed by the precoding unit 156. The precoding technique adopted may be zero forcing based on orthogonal property, interference alignment, or other precoding techniques. The implementation of precoding technique is not limited herein. After precoding, the UL-to-DL interference and the DL-to-UL interference between neighboring base stations may be cancelled. In other words, the first user equipment UE11 transmitting data in UL does not interfere with the first base station BS11 transmitting data in DL to the second user equipment UE12. The first base station BS11 transmitting data in DL does not interfere with the first user equipment UE11 transmitting data in UL to the second base station BS12. As described above, the network server 10 may be connected to the base stations. A precoding result of the step of performing precoding on the transmitting antennas may be transmitted to the first base station BS11 (precoding result of DL) and the second base station BS12 (precoding result of UL), and may be transmitted to the first equipment UE11 via the second base station BS12.

The grouping unit 152, the channel processing unit 154, and the precoding unit 156 may be implemented by software, such as application programs installed in the network server 10. The network server 10 may include a processor and a memory. The code of the application programs may be stored in the memory and may be loaded by the processor to execute the application programs. The grouping unit 152, the channel processing unit 154, and the precoding unit 156 may also be implemented by hardware, such as circuits with the corresponding functionality.

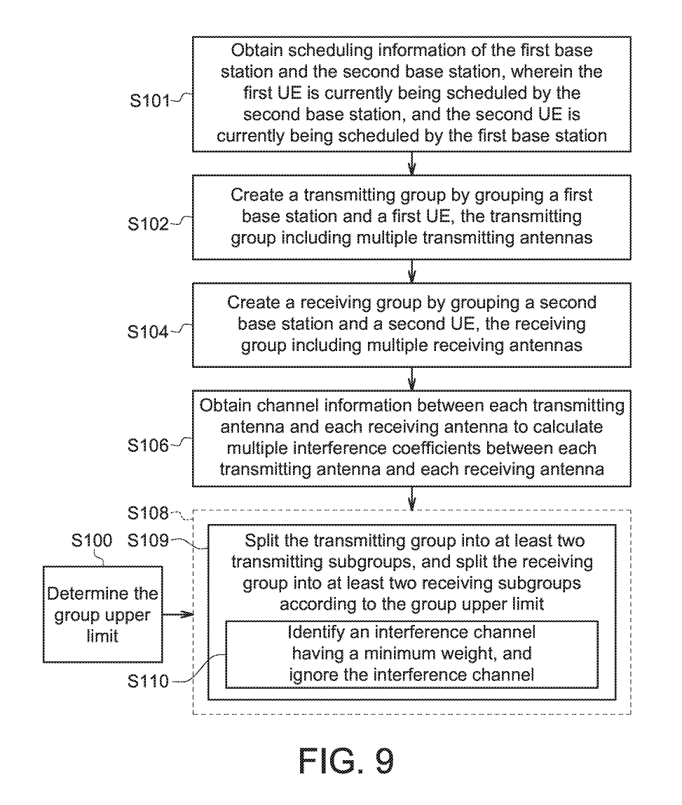

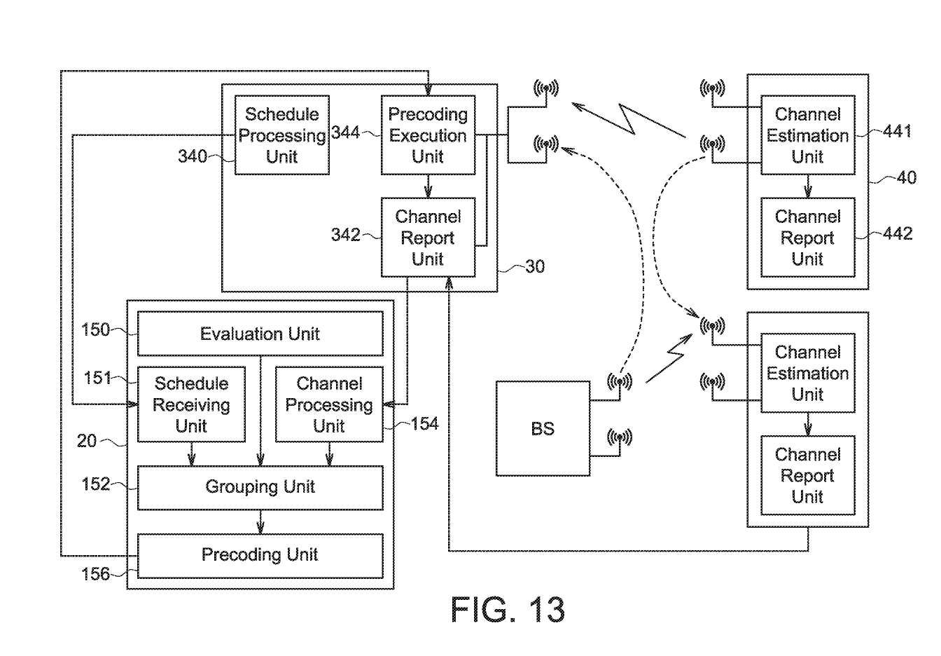

FIG. 9 shows a flowchart illustrating an interference mitigation method according to an embodiment of this disclosure. The flowchart shown in FIG. 9 further includes steps S100, S101, S109 and S110 as compared to the flowchart shown in FIG. 8. FIG. 11 shows a block diagram of the network server according to an embodiment of this disclosure. The network server 20 further includes an evaluation unit 150 and a schedule receiving unit 151 as compared to the network server 10 shown in FIG. 10.

Step S101: Obtain scheduling information of the first base station BS11 and the second base station BS12, wherein the first user equipment UE11 is currently being scheduled by the second base station BS12, and the second user equipment UE 12 is currently being scheduled by the first base station BS11. The step S101 may be performed by the schedule receiving unit 151. The network server 20 may collect identification code of users that are to be scheduled in UL or DL from each connected base station. For example, the network server 20 may know that the second user equipment UE12 is currently being scheduled in the DL schedule from the first base station BS11, and know that the first user equipment UE11 is currently being scheduled in the UL schedule from the second base station BS12. The grouping procedure (corresponding to the steps S102 and S104) regarding which base station and which user equipment are grouped together may be determined based on the scheduling information. In addition, the schedule receiving unit 151 may also obtain from the base station the antenna corresponding relationship between the base station and the user equipment. For example, which antenna of the first base station BS11 is assigned to correspond to a particular antenna of the second user equipment UE12, and which antenna of the second base station BS12 is assigned to correspond to a particular antenna of the first user equipment UE11. The interference coefficients may be calculated according to the antenna corresponding relationship (step S106).

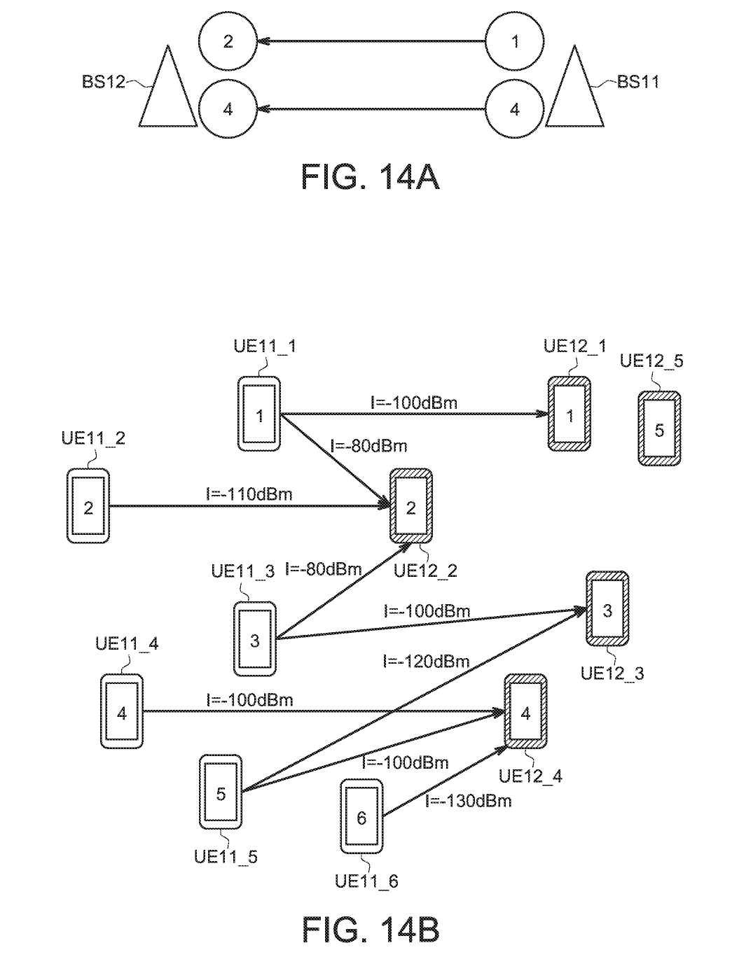

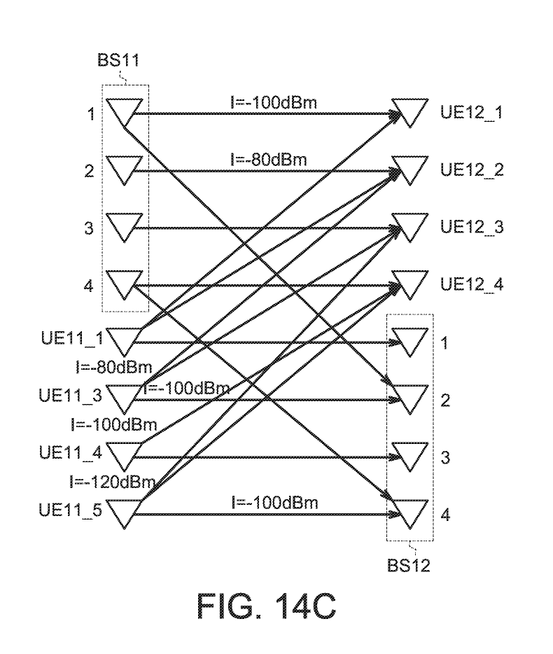

In one embodiment, a base station is provided in this disclosure. FIG. 12 shows a block diagram of the base station according to an embodiment of this disclosure. The base station 30 includes a schedule processing unit 340, a channel report unit 342, and a precoding execution unit 344. FIG. 13 shows a diagram illustrating the network server 20, the base station 30 and the user equipment 40 according to an embodiment of this disclosure. The network server 20 has been described above with reference to FIG. 11. The user equipment 40 includes a channel estimation unit 441 and a channel report unit 442, performing channel estimation and reporting the channel estimation result to a corresponding base station, respectively. The units in the base station 30 are described below.

The schedule processing unit 30 is configured to identify a user equipment 40 that is currently being scheduled, and transmit information about the base station 30 and the user equipment 40 to a network server 20 (corresponding to the step S101). The channel report unit 342 is configured to obtain base station channel information related to the base station 30, obtain user equipment channel information related to the user equipment 40, and transmit the base station channel information and the user equipment channel information to the network server 20. Specifically, the base station 30 itself may perform channel estimation to obtain channel responses with neighboring base stations and with serving user equipments. These channel responses belong to the base station channel information. The user equipment 40 may also perform channel estimation to obtain channel responses with its serving base station and with neighboring user equipments. These channel responses belong to the user equipment channel information. The channel estimation result obtained by the user equipment 40 is first transmitted to the base station 30, and then is transmitted to the network server 20 via the base station 30 (corresponding to the step S106). The precoding execution unit 344 is configured to receive a precoding result from the network server 20 and to implement it in current transmission (corresponding to the step S108).

The base station 30 includes multiple antennas. When the base station 30 is performing DL transmission, the base station 30 belongs to the transmitting group Tx1. The precoding execution unit 344 is further configured to perform precoding on the antennas according to the precoding result. On the other hand, when the base station is performing UL transmission, the base station 30 belongs to the receiving group Rx1. The user equipment 40 served by the base station 30 then belongs to the transmitting group Tx1. Therefore the precoding execution unit 344 is further configured to transmit the precoding result to the user equipment 40 (referring to the description about the step S108).

The schedule processing unit 340, the channel report unit 342, and the precoding execution unit 344 of the base station 30 may be implemented by software, firmware, or hardware. For example, an application program with corresponding functions may be installed in the base station 30. Alternatively, circuits with corresponding functions may be disposed in the base station 30.

In the above examples, the transmitting group Tx1 includes only one base station BS11 and only one user equipment UE11. The receiving group Rx1 includes only one base station BS12 and only one user equipment UE12. However, the examples are just exemplary rather than limiting. The examples given are simplified for ease of understanding the method for interference mitigation proposed in this disclosure. In real applications there may be hundreds or thousands of base stations and mobile phones in a group. When there are thousands of antennas in one group, the precoding calculation by matrix computation in the step S108 may consume so much time and resource that a processor or the corresponding circuit may not be able to produce a precoding result in time. Therefore the method for interference mitigation may further include the step S100, S109 and S110 as shown in FIG. 10.

Step S100: determine the group upper limit Amax. The step may be performed by the evaluation unit 150. The group upper limit Amax may be determined according to the hardware resource of the network server 20, such as clock rate of the central processing unit (CPU), capacity of the memory, current program loading amount, etc. If the number of antennas in the transmission group Tx1 (or the receiving group Rx1) created in the step S102 (or step S104) exceeds the group upper limit Amax, the network server 20 may not be able to produce the precoding result in time, then step S109 may be performed. Step S109: split the transmitting group Tx1 into at least two transmitting subgroups, and split the receiving group Rx1 into at least two receiving subgroups according to the group upper limit Amax. The number of transmitting subgroups may be equal to the number of receiving subgroups. Step S109 may be performed by the grouping unit 152.

There may be multiple methods to implement the step S109 of splitting a group into subgroups, such that each transmitting subgroup includes at least one base station and at least one user equipment, each receiving subgroup includes at least one base station and at least one user equipment (as shown in the example system in FIG. 3), the number of antennas in each transmitting subgroup is less than or equal to the group upper limit Amax, and the number of antennas in each receiving subgroup is less than or equal to the group upper limit Amax. The objective of the step S109 is to split one group into two subgroups (may also be more than two groups, two groups are used here for ease of understanding) such that there is no interference channel between the two subgroups. Therefore the precoding calculation may be performed on two independent subgroups individually. In a graph representation, the system may be regarded as a graph G. Each antenna may be represented as a vertex in the graph G. An interference channel that exists between antennas may be represented as an edge in the graph G. The step S109 is to divide the graph G into two subgraphs such that there is no edge between these two subgraphs.

One possible implementation of the step S109 is to ignore interference coefficients that are small enough. That is, for a channel that has a too small interference coefficient, the channel may be regarded as no interference and thus the interference channel may be removed in order to split the group into smaller subgroups. In one embodiment, the graph G may be analyzed to know which edge(s) can be removed in order to divide the graph G into two subgraphs. Then whether or not the interference coefficient of the edge(s) to be removed is small enough is determined. In another embodiment, the minimum interference coefficient and the corresponding interference channel is identified, and then the corresponding interference channel is ignored.

The step S109 may include step S110: identify an interference channel having a minimum weight, and ignore the interference channel. The weight in the step S110 may be determined by topology analysis of the graph G and/or the interference coefficients. For example, a channel with small interference coefficient may be assigned a small weight. In addition, an edge that helps to divide the graph G into two subgraphs may be assigned a small weight as well. The step S110 may be performed by the grouping unit 152. After removing the interference channel, determine whether or not the graph G can be divided into two subgraphs. If the graph G still cannot be divided, the step S110 may be performed repeatedly to identify another interference channel having a minimum weight and remove the identified interference channel.

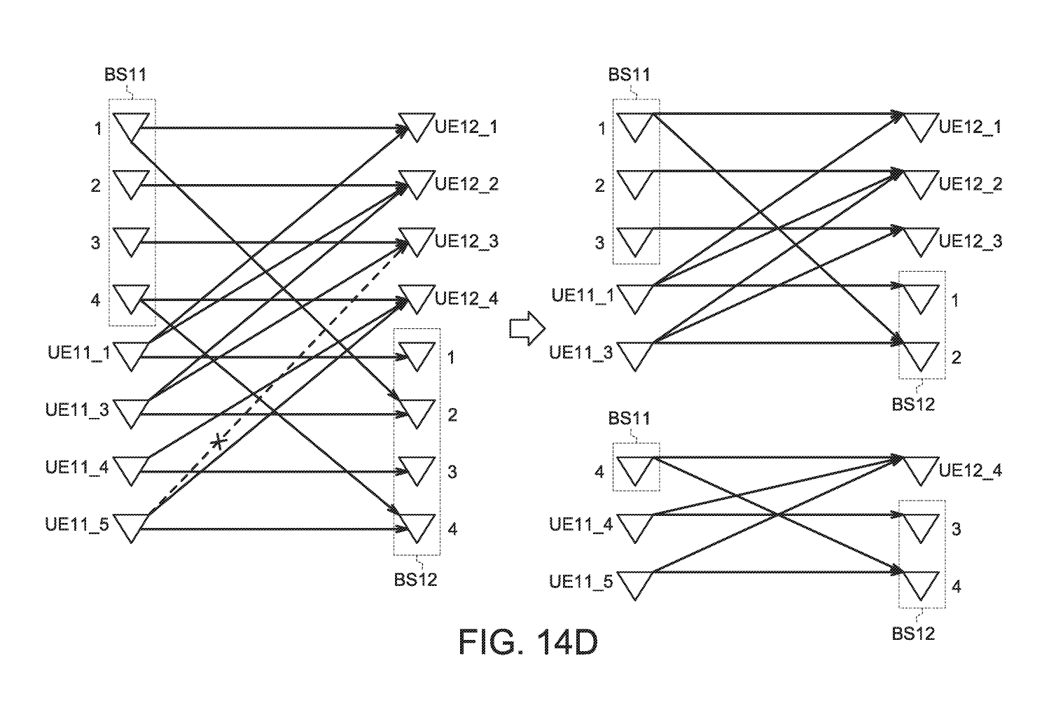

An example of splitting a group is shown in FIG. 14A-FIG. 14D. In this example, the first base station BS11 has four antennas, and so does the second base station BS12. There are five second user equipments UE12_1-UE12_5 in the coverage area of the first base station BS11. There are six first user equipments UE11_1-UE11_6 in the coverage area of the second base station BS12. FIG. 14A shows a diagram illustrating an example of interference between base stations. After collecting channel information and calculating interference coefficients, it is known that there is interference between the first antenna of the first base station BS11 and the second antenna of the second base station BS12. There is also interference between the fourth antenna of the first base station BS11 and the fourth antenna of the second base station BS12. FIG. 14B shows a diagram illustrating an example of interference between user equipments. The shaded mobile phones shown in the right-hand side of FIG. 14B are the second user equipments UE12_1-UE12_5, and the mobile phones shown in the left-hand side of FIG. 14B are the first user equipments UE11_1-UE11_6. The calculated interference coefficients between each antenna are shown in FIG. 14B. The channel where there is no interference coefficient represents that the interference coefficient is so small that may be ignored.

FIG. 14C shows a diagram illustrating an example of grouping the base station and the user equipment. In addition to the interference channels shown in FIG. 14A and FIG. 14B, there are also interference channels between a base station and a user equipment, which are shown in FIG. 14C. In this example, because the first user equipment UE11_2 and UE11_6 are not currently being scheduled by the second base station BS12, the first user equipment UE11_2 and UE11_6 are not shown in FIG. 14C. The system may be represented as a graph G. There are eight vertices (antennas) in both the transmitting terminal and the receiving terminal. In this example the allowable group upper limit Amax is equal to 6. Hence the graph G has to be divided. FIG. 14D shows a diagram illustrating an example of splitting a group into two subgroups. The minimum interference coefficient in this system is −120 dBm from the first equipment UE11_5 to the second equipment UE12_3. This edge is thus removed from the graph G. The graph G can be divided into two subgraphs as shown in FIG. 14D after removing this edge. There is no edge connecting these two subgraphs, that is, there exists no interference channel between these two subgroups. Precoding operation may be performed on these two separate subgroups, fulfilling the requirement of the allowed group upper limit Amax.

In the above example, the number of transmitting antennas is equal to the number of receiving antennas for ease of understanding the operation of precoding, grouping, and group splitting. The invention is not limited thereto. In real applications the number of transmitting antennas may be different from the number of receiving antennas. In such case, the transmitting group Tx1 may be created and a receiving group Rx1 with the same number of antennas as in the transmitting group Tx1 may be created according to the weight parameter and/or scheduling priority. By utilizing the method for interference mitigation in this disclosure, the interference condition between neighboring base stations and multiple user equipments can be considered simultaneously, such that the interference caused by the neighboring base stations using different TDD configurations can be avoided. Furthermore, the computation power can be evaluated to adjust the computation amount of the interference mitigation method. Consequently the interference mitigation can be guaranteed to be performed completely within predetermined time duration.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for interference mitigation, comprising:
creating a transmitting group by grouping a first base station and a first user equipment, the transmitting group comprising a plurality of transmitting antennas;
creating a receiving group by grouping a second base station and a second user equipment, the receiving group comprising a plurality of receiving antennas;
obtaining channel information between each transmitting antenna and each receiving antenna to calculate a plurality of interference coefficients between each transmitting antenna and each receiving antenna; and
performing precoding on the transmitting antennas according to the interference coefficients.

2. The method according to claim 1, wherein the channel information comprises:
a channel response between the first base station and the second base station;
a channel response between the first base station and the second user equipment;
a channel response between the first user equipment and the second base station; and
a channel response between the first user equipment and the second user equipment.

3. The method according to claim 1, further comprising:
obtaining scheduling information of the first base station and the second base station;
wherein the first user equipment is currently being scheduled by the second base station, and the second user equipment is currently being scheduled by the first base station.

4. The method according to claim 3, wherein the first base station transmits data to the second user equipment in a downlink channel, and the first user equipment transmits data to the second base station in an uplink channel.

5. The method according to claim 1, further comprising:
determining a group upper limit; and
splitting the transmitting group into at least two transmitting subgroups, and splitting the receiving group into at least two receiving subgroups according to the group upper limit;
wherein each transmitting subgroup comprises at least one base station and at least one user equipment, each receiving subgroup comprises at least one base station and at least one user equipment, the number of antennas in each transmitting subgroup is less than or equal to the group upper limit, and the number of antennas in each receiving subgroup is less than or equal to the group upper limit.

6. The method according to claim 5, further comprising:
identifying an interference channel having a minimum weight, and ignoring the interference channel.

7. The method according to claim 1, wherein a precoding result of the step of performing precoding on the transmitting antennas is transmitted to the first base station and the second base station, and is transmitted to the first user equipment via the second base station.

8. The method according to claim 1, wherein the first base station and the second base station use different time division duplex configurations.

9. A network server, comprising:
a grouping unit, configured to create a transmitting group by grouping a first base station and a first user equipment, and create a receiving group by grouping a second base station and a second user equipment, wherein the transmitting group comprises a plurality of transmitting antennas, and the receiving group comprises a plurality of receiving antennas;
a channel processing unit, configure to obtain channel information between each transmitting antenna and each receiving antenna to calculate a plurality of interference coefficients between each transmitting antenna and each receiving antenna; and
a precoding unit, configured to perform precoding on the transmitting antennas according to the interference coefficients.

10. The network server according to claim 9, wherein the channel information comprises:
a channel response between the first base station and the second base station;
a channel response between the first base station and the second user equipment;
a channel response between the first user equipment and the second base station; and
a channel response between the first user equipment and the second user equipment.

11. The network server according to claim 9, further comprising a schedule receiving unit, configured to obtain scheduling information of the first base station and the second base station, wherein the first user equipment is currently being scheduled by the second base station, and the second user equipment is currently being scheduled by the first base station.

12. The network server according to claim 11, wherein the first base station transmits data to the second user equipment in a downlink channel, and the first user equipment transmits data to the second base station in an uplink channel.

13. The network server according to claim 9, further comprising an evaluation unit, configured to determine a group upper limit;
wherein the grouping unit is further configured to split the transmitting group into at least two transmitting subgroups and split the receiving group into at least two receiving subgroups according to the group upper limit, each transmitting subgroup comprises at least one base station and at least one user equipment, each receiving subgroup comprises at least one base station and at least one user equipment, the number of antennas in each transmitting subgroup is less than or equal to the group upper limit, and the number of antennas in each receiving subgroup is less than or equal to the group upper limit.

14. The network server according to claim 13, wherein the grouping unit is further configured to identify an interference channel having a minimum weight and ignore the interference channel.

15. The network server according to claim 9, wherein a precoding result generated by the precoding unit performing precoding on the transmitting antennas is transmitted to the first base station and the second base station, and is transmitted to the first user equipment via the second base station.

16. The network server according to claim 9, wherein the first base station and the second base station use different time division duplex configurations.

17. A base station, comprising:
a schedule processing unit, configured to identify a user equipment that is currently being scheduled, and transmit information about the base station and the user equipment to a network server;
a channel report unit, configured to obtain base station channel information related to the base station, obtain user equipment channel information related to the user equipment, and transmit the base station channel information and the user equipment channel information to the network server; and
a precoding execution unit, configured to receive a precoding result from the network server.

18. The base station according to claim 17, further comprising a plurality of antennas, wherein the precoding execution unit is further configured to perform precoding on the antennas according to the precoding result.

19. The base station according to claim 17, wherein the precoding execution unit is further configured to transmit the precoding result to the user equipment.
